(19) United States
(12) Patent Application Publication
(10) Pub. No.: US 2024/0280029 A1
(43) Pub. Date: Aug. 22, 2024

(54) ROTOR DISK FOR A BLADE RING

(71) Applicant: MTU Aero Engines AG, Muenchen (DE)

(72) Inventor: Matthias SIEBEL, Munich (DE)

(21) Appl. No.: 18/648,594

(22) Filed: Apr. 29, 2024

(30) Foreign Application Priority Data
May 3, 2023 (DE) 102023111513.8

(51) Int. Cl. F01D 5/30; F01D 5/02

(52) U.S. Cl. CPC F01D 5/3023; F01D 5/021; F05D 2300/17

(57) ABSTRACT

A rotor disk for a blade ring of an aircraft engine, in particular for a turbine stage thereof, including an attachment section for attachment to a shaft for torque transfer, a main section that extends radially inwardly from a blade root receptacle in the radial direction, a connecting section that connects the attachment section and the main section, and a plurality of through openings, situated in the circumferential direction, at a radially inner end of the connecting section. A rotor disk whose stresses are reduced in the event of load is provided in that the connecting section has an undercut. An apex of the undercut is radially situated above the through opening in the range of 5%-50% of the axial length of a through opening, and/or is axially spaced apart from an axial end of the through opening at 5%-35% of the axial length of the through opening.

This claims the benefit of German Patent Application DE 102023111513.8, filed May 3, 2023 and is hereby incorporated by reference herein.

The present invention relates to a rotor disk for a blade ring of an aircraft engine, in particular for a turbine stage thereof, including an attachment section for attachment to a shaft for torque transfer, a main section that extends radially inwardly from a blade root receptacle in the radial direction, a connecting section that connects the attachment section and the main section, and a plurality of through openings, situated in the circumferential direction, at a radially inner end of the connecting section.

### BACKGROUND

Rotor disks of blade rings in aircraft engines are operated at high rotational speeds, and therefore are subjected to high centrifugal forces and intense vibrations that result in high component stresses in the rotor disk. Various measures are known for protecting the rotor disks and reducing the stresses. For example, the rotor disks may have a reinforced design, or the rotor blade geometries may be designed in such a way that the smallest possible mechanical oscillations act on the rotor disks. In addition, providing imbalances at the rotor disks may result in a reduction of the stresses, due to reduced oscillation stresses. Thus, many measures are known which already achieve an improvement in the service life of the rotor disks. Against this background, it is particularly difficult to further increase the service life.

### SUMMARY OF THE INVENTION

It is an object of the present invention to provide a rotor disk, a turbine stage, and an aircraft engine whose service lives are further increased.

The present invention provides a rotor disk, a turbine stage, and an aircraft engine.

A rotor disk according to the present invention for a blade ring of an aircraft engine, in particular for a turbine stage thereof, includes an attachment section for attachment to a shaft for torque transfer, a main section that extends radially inwardly from a blade root receptacle in the radial direction, a connecting section that connects the attachment section and the main section, and a plurality of through openings, situated in the circumferential direction, at a radially inner end of the connecting section. The attachment section, which is used as a hub, may be a ring-shaped section of the rotor disk which is wider or broader than the rest of the rotor disk, in particular compared to the connecting section, the main section, and the blade receptacle, and which may transfer a torque of the shaft from or to the rest of the rotor disk. The connecting section, situated farther radially outwardly, connects the main section and the attachment section of the rotor disk. The connecting section at its radial inner end section includes through openings that allow flow of the air through the rotor disk near the shaft attachment. This air is used to cool the rotor disk. In addition, the cross section of the connecting section in its radial extension up to the main section has a thinner design than the attachment section. This design is used for low torque resistance, but results in higher stress in the component. The main section in turn has a wider cross section in the radial direction. The rotor disk radially outwardly terminates with a blade receptacle section, the blades being inserted into a blade receptacle situated there. In addition, a disk connection to neighboring rotor disks is situated in this blade receptacle section, so that a rotor drum made up of multiple rotor disks may be formed. The disk connections of two rotor disks are fastened to one another via bolts. The neighboring rotor disks are not necessarily connected to the shaft, so that a torque transfer for multiple rotor disks takes place via the rotor disk according to the present invention that includes an attachment section.

The object is achieved by the rotor disk according to the present invention of claim 1 in that the connecting section has an undercut, an apex of the undercut being radially situated above the through opening at a radial distance in the range of 5%-50%, preferably 10-30%, in particular 15-25%, of the axial length of a through opening, and/or being axially spaced apart from an axial end of the through opening at an axial distance in the range of 5%-35%, preferably 10%-25%, in particular 10%-20%, of the axial length of the through opening, in particular in the direction toward an opposite end of the through opening. Due to an undercut in this area, the local stresses in the rotor disk that occur during operation of the aircraft engine are greatly reduced. In particular, as a result of an apex of the undercut, as described, being spaced apart from the through openings or from an end of the through openings, the stresses may be distributed over a larger surface, resulting in lower maximum stress and thus a great increase in the service life of the rotor disk. A lower radial end of the undercut may directly adjoin the through openings, or may begin at a distance from the through openings. In addition, the present invention has the surprising effect that the component robustness during manufacture of the through openings is increased.

Further advantages and features result from the following description of several preferred exemplary embodiments.

In one advantageous specific embodiment of the present invention, the through openings extend in the axial direction. Particularly efficient cooling of the rotor drum may thus take place, which further increases the service life. Alternatively or additionally, the through openings may also include a radial profile portion. Furthermore, the through openings may all have an identical design. The through openings may also include bolts for closing the through openings and/or for fastening further components.

The attachment section, the main section, and the connecting section preferably have an integral, monolithic, and/or one-piece design.

In a further advantageous specific embodiment of the present invention, the undercut is situated on a side of the connecting section pointing in the flow direction. This arrangement of the undercut has resulted in surprisingly favorable stress profiles that increase a life expectancy of the rotor disk.

In one particularly preferred embodiment, the rotor disk is manufactured from a nickel-based material and/or from a powder metallurgical material. The service life may thus be advantageously increased compared to use of other materials.

In a further specific embodiment of the rotor disk, the attachment section has an axial offset relative to the blade root receptacle. The attachment section may in particular have an axial offset in a direction opposite the flow direction. As the result of an axial offset, a bending moment of the rotor disk is advantageously increased over the entire radial height of the rotor disk, which advantageously influences the stress profiles. The axial offset may be measured in particular between the centers of gravity of the attachment section and the blade root receptacle. The axial offset may particularly preferably be measured between the centroids of area of the attachment section and of the blade root receptacle in a meridian section that intersects a midpoint of one of the through openings and the rotor rotational axis.

The rotor disk may in particular be refined in such a way that the axial offset is between 50% and 200% of the axial length of the through opening. It has been shown that an axial offset in this range has a particularly advantageous effect on the component stresses on the rotor disk.

In a further advantageous embodiment, the rotor disk may be refined in such a way that during operation, one or multiple of the through openings are open and free of a bolt. This results in cooling in particular of the attachment section and the connecting section, which reduces the thermal stresses.

In one advantageous refinement of the rotor disk, an angle at an intersection point between a surface of the undercut and an end of the through opening may be greater than 20°, in particular greater than 45°, and less than 80°. Such transitions in the undercut result in low stresses at the intersection point. A rounding may be provided at the intersection point which further reduces the surface stresses in the area of the intersection point. Since the imaginary intersection point is no longer situated on the component, but instead is situated in a geometry remote from the rounding, the angle in particular may be defined between a first tangent of the surface of the undercut adjoining the rounding and a second tangent of the end of the through opening, starting from the end of the through opening and adjoining the rounding.

A second aspect of the present invention relates to a turbine stage, in particular a low-pressure turbine stage, that includes a rotor disk as described above. Due to the use of a rotor disk as described above, the service life of the turbine stage is also increased and the maintenance costs are lowered.

A third aspect of the present invention relates to an aircraft engine that includes a rotor disk as described above or a turbine stage as described above.

### BRIEF DESCRIPTION OF THE DRAWINGS

The present invention is explained in greater detail with reference to the following drawings, based on several preferred exemplary embodiments of the present invention.

FIG. 1 shows one exemplary embodiment of an aircraft engine according to the present invention, including a turbine stage according to the present invention and a rotor disk according to the present invention in a meridian section;

FIG. 2 shows one exemplary embodiment of a rotor disk according to the present invention in a meridian section; and

FIG. 3 shows a detail of the exemplary embodiment of the rotor disk according to the present invention in a meridian section.

### DETAILED DESCRIPTION

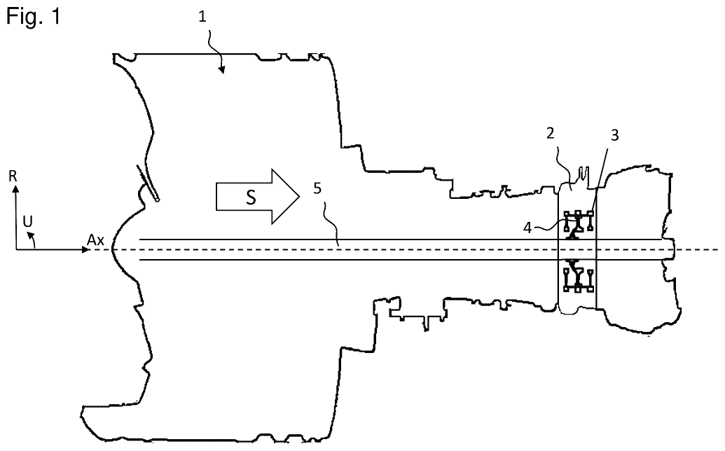

FIG. 1 illustrates one exemplary embodiment of an aircraft engine 1 according to the present invention, including a turbine stage 2 in a meridian section. Turbine stage 2 includes a blade ring 3, with a rotor disk 4 according to the present invention 4 that is connected to a shaft 5 of aircraft engine 1.

The main directions of aircraft engine 1 are designated based on shaft 5, an axial direction Ax extending in the direction of the shaft longitudinal axis illustrated by dashed lines. A radial direction R extends orthogonally thereto. Axial direction Ax and a radial direction R form the basis for a meridian plane that is the basis for a meridian section through aircraft engine 1. A third main direction of aircraft engine 1 is a circumferential direction U that extends around axial direction Ax. A flow direction S of a flow channel inside aircraft engine 1 extends largely in axial direction Ax.

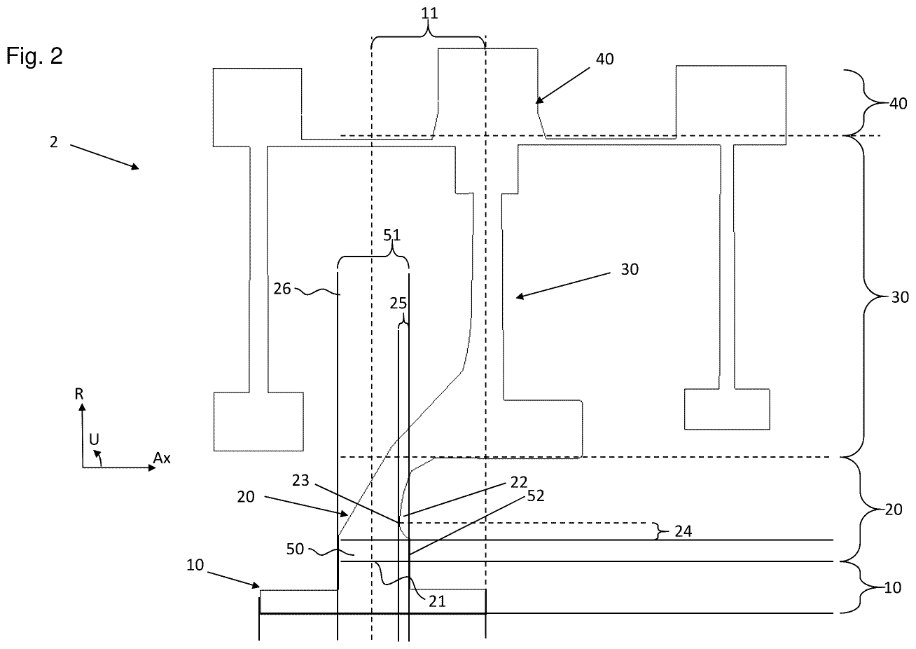

FIG. 2 illustrates rotor disk 4 according to the present invention in a meridian section. Rotor disk 4 includes an attachment section 10, a connecting section 20, a main section 30, and a blade root receptacle 40. Attachment section 10 is used to attach to shaft 5 for torque transfer. Main section 30 extends radially inwardly from blade root receptacle 40 in radial direction R and opens into connecting section 20, which in turn connects attachment section 10 and main section 30. A plurality of through openings 50 situated in circumferential direction U, one of which is illustrated in cross section in the meridian section of FIG. 2, are situated at a radially inner end 21 of connecting section 20. Through openings 50 have a cylindrical shape and an axial profile. In the present exemplary embodiment, most of through openings 50 have a continuous design and are free of bolts. Bolts for closing or for fastening further components may be provided in some through openings 50. Rotor disk 4 is made of a powder metallurgical nickel-based material.

According to the present invention, it is provided that connecting section 20 has an undercut 22, in the present exemplary embodiment an apex 23 of undercut 22 being situated radially above through opening 50 at 20% of axial length 51 of through opening 50. In addition, in the present exemplary embodiment, apex 23 of undercut 22 is axially spaced apart from an axial end 52 of through opening 50 at an axial distance 25 that is 15% of axial length 51 of through opening 50. In the present exemplary embodiment, undercut 22 is situated on a side 26 of connecting section 20 pointing in flow direction S.

Attachment section 10 has a design that is offset relative to blade root receptacle 40 with an axial offset 11 opposite flow direction S. In the present meridian section through a center of through openings 50, i.e., through a largest cross section of through openings 50 in radial direction R, the centroids of area of attachment section 10 and of blade root receptacle 40 are plotted in each case, and are used as dimension lines for measuring axial offset 11. Axial offset 11 is 150% of axial length 51 of through opening 50.

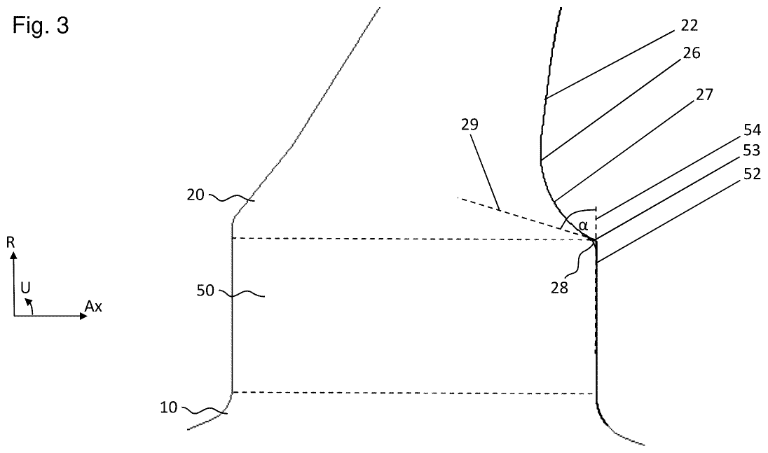

FIG. 3 shows an enlarged detail of the illustration from FIG. 2 and a transition of attachment section 10 to connecting section 20. Undercut 22 is illustrated in greater detail. Undercut 22 has a surface 27, and adjoins axial end 52 of through opening 50. Apart from a rounding 28, surface 27 and axial end 52 form an intersection point 53. An angle α that is plotted at an intersection point 53 between a first tangent 29 of surface 27 of undercut 22 and a second tangent 54 that starts from axial end 52 of through opening 50 is 65°. Rounding 28 is provided so that no sharp edge results between surface 27 of undercut 22 and axial end 52 of through opening 50.

### LIST OF REFERENCE SYMBOLS

1 aircraft engine
2 turbine stage
3 blade ring
4 rotor disk
5 shaft
10 attachment section
11 axial offset
20 connecting section
21 radial inner end
22 undercut
23 apex
24 radial distance
25 axial distance
26 side pointing in the flow direction
27 surface
28 rounding
29 first tangent
30 main section
40 blade root receptacle
50 through opening(s)
51 axial length
52 axial end
53 intersection point
S flow direction
Ax axial direction of the aircraft engine
R radial direction of the aircraft engine
U circumferential direction of the aircraft engine
α angle

What is claimed is:

1. A rotor disk for a blade ring of an aircraft engine, the rotor disk comprising:
an attachment section for attachment to a shaft for torque transfer;
a main section extending radially inwardly from a blade root receptacle in the radial direction;
a connecting section connecting the attachment section and the main section;
a plurality of through openings, situated in a circumferential direction, at a radially inner end of the connecting section; the connecting section having an undercut, an apex of the undercut:
being radially situated above the through opening at a radial distance in the range of 5%-50% of an axial length of a through opening, or
being axially spaced apart from an axial end of the through opening at an axial distance in the range of 5%-35% of the axial length of the through opening.

2. The rotor disk as recited in claim 1 wherein the through openings extend in the axial direction.

3. The rotor disk as recited in claim 1 wherein the attachment section, the main section, and the connecting section have an integral design.

4. The rotor disk as recited in claim 1 wherein the undercut is situated on a side of the connecting section pointing in the flow direction.

5. The rotor disk as recited in claim 1 wherein the rotor disk is manufactured from a nickel-based material or from a powder metallurgical material.

6. The rotor disk as recited in claim 1 wherein the attachment section has an axial offset relative to the blade root receptacle.

7. The rotor disk as recited in claim 6 wherein the axial offset is in a direction opposite the flow direction.

8. The rotor disk as recited in claim 6 wherein the axial offset is between 50% and 200% of the axial length of the through opening.

9. The rotor disk as recited in claim 1 wherein during operation, one or multiple of the through openings are open and free of a bolt.

10. The rotor disk as recited in claim 1 wherein an angle at an intersection point between a surface of the undercut and an end of the through opening is greater than 20° and less than 45.

11. The rotor disk as recited in claim 10 wherein the angle is greater than 30°, and a rounding is provided at the intersection point, and the angle being defined between a first tangent of the surface of the undercut adjoining the rounding and a second tangent of the axial end of the through opening, starting from the axial end of the through opening and adjoining the rounding.

12. The rotor disk as recited in claim 1 wherein the apex is radially situated above the through opening at the radial distance.

13. The rotor disk as recited in claim 12 wherein the apex is situated in the range of 10-30% of the axial length of the through opening.

14. The rotor disk as recited in claim 12 wherein the apex is situated in the range of 15-25% of the axial length of the through opening.

15. The rotor disk as recited in claim 1 wherein the apex is axially spaced apart from the axial end of the through opening.

16. The rotor disk as recited in claim 15 wherein the apex is situated in the range of 10-25% of the axial length of the through opening.

17. The rotor disk as recited in claim 12 wherein the apex is situated in the range of 10-20% of the axial length of the through opening.

18. A turbine stage comprising the rotor disk as recited in claim 1.

19. The turbine stage as recited in claim 18 wherein the turbine stage is a low-pressure turbine stage.

20. An aircraft engine comprising the rotor disk as recited in claim 1.
